(19) United States
(12) Patent Application Publication
(10) Pub. No.: US 2016/0348468 A1
(43) Pub. Date: Dec. 1, 2016

(54) FLUID PRESSURE RELEASE SYSTEM FOR USE IN HIGH PRESSURE RELIEF SYSTEMS

(71) Applicant: Charles M. BLACKLOCK, Houston, TX (US)

(72) Inventor: Charles M. BLACKLOCK, Houston, TX (US)

(73) Assignee: Best Flow Line Equipment. L.P., Houston, TX (US)

(21) Appl. No.: 14/723,089

(22) Filed: May 27, 2015

(51) Int. Cl. E21B 34/02; F16K 1/52

(52) U.S. Cl. CPC E21B 34/02; F16K 1/52

(57) ABSTRACT

A fluid pressure release system for use in a stimulation, high-pressure application, and flow back operation has a piping system with an interior passageway, a plug valve connected to the piping system, and a choke valve connected or interconnected to the plug valve. The plug valve has an interior in communication with the interior passageway of the piping system. The plug valve can be movable between an open position and a closed position. The choke valve includes a choke carrier with a first end connected or interconnected to an end of the plug valve opposite the piping system, and a choke bean affixed within an internal bore of the choke carrier. The choke bean has a longitudinal bore extending therethrough so as to allow for the discharge of pressurized fluid therethrough.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to fluid pressure release systems. More particularly, the present invention relates to such fluid pressure release systems as used in high pressure relief systems fracturing operations. More particularly, the present invention relates to choke valves as used for the release of fluid pressure.

2. Description of Related Art Including Information Disclosed Under 37 CFR 1.97 and 37 CFR 1.98.

Wells are frequently used to extract fluids, such as oil, gas and water, from subterranean reserves. These fluids, however, are often expensive to extract because they naturally flow relatively slowly to the wellbore. Frequently, a substantial portion of the fluid is separated from the well by bodies of rock and other solid materials that may be located in isolated cracks within a formation. The solid formations impede fluid flow to the well and tend to reduce the well's rate of production.

This effect, however, can be mitigated with certain well-enhancement techniques. Well output often can be boosted by stimulation and flow back operation. To stimulate a well, a fluid is pumped into the well until the downhole pressure rises, causing cracks to form in the surrounding rock. The fluid flows into the cracks, causing the cracks to propagate away from the well and toward more distant fluid reserves. To impede the cracks from closing after the stimulation pressure is removed, the fluid typically carries a substance referred to as a proppant. The proppant is typically a solid permeable material, such as sand, that remains in the cracks and holds them at least partially opened after the pressure is released. The resulting porous passages provide a lower resistance path for the extracted fluid to flow to the wellbore, thereby increasing the well's rate of production.

The stimulation of a well produces pressures in the well that are greater than the pressure-rating of certain well components. For example, some stimulation operations, which are temporary procedures and encompass a small duration of a well's life, can produce pressures that are greater than 10,000 p.s.i. In contrast, pressures naturally arising from the extracted fluid during the vast majority of the well's life may be less than 5,000 p.s.i. Wellhead equipment rated for 10,000 p.s.i. may be more costly to purchase and operate in wellhead equipment rated for 5,000 p.s.i. However, for safety reasons, the equipment is purchased based upon the highest pressure rating during the life of the well.

During the stimulation and flow back operations, it is often necessary to release the pressures. The release of pressures can be occasioned as a result of the completion of the stimulation operation. In other circumstances, instances may occur whereby an emergency release of pressure is required. As such, a need has developed whereby the pressures of a well can be quickly and easily released in a controlled manner. In the past, double-stacked valves have been employed for the release of pressure. One of the valves of the double stack is a on/off valve. The other valve that is used is often a conventional throttling or torture valve. In order to release pressure, the throttling valve must be slowly opened and closed so that pressure is gradually released. This slow release of pressure is in the nature of the slow opening of a soft drink bottle such that the pressures can be slowly released until an acceptable level of pressure is retained. At that time, the throttling valve can be fully open so that remaining pressure can be released. The throttling operation is often very slow and can be unsafe. Experienced operators are required to effectively operate the throttling valve once the on/off valve is opened. In many circumstances, too much pressure is released beyond an acceptable safety level. In other circumstances, the pressure is released very slowly. If emergency procedures are required, then that slow release of pressure may impede the emergency operations.

In other circumstances, these valves rapidly erode because of the abrasive materials used in the fluid within the stimulation and flow back operation. The high-velocity high-pressure passage of fluid through the valves rapidly erodes the valves. As such, the throttling or torture valve must be replaced repeatedly after a sufficient amount of erosion has occurred. The replacement of such a throttling valve can be expensive, time-consuming and difficult. As such, a need has developed so as to facilitate the release of pressures from the fracturing operation without the need for continual replacement of the throttling valves.

During the release of pressures, the pressures in the well must be continually monitored. Once the torture or throttling valve is opened, it will be necessary to close the on-off valve when pressures reach a certain level. As such, the release of pressure requires constant monitoring in order to assure that safety is preserved during the release of pressure.

In the past, various patents have issued relating to pressure relief systems. For example, U.S. Pat. No. 4,105,049, issued on Aug. 8, 1978 to C. E. Anderson, shows an abrasive resistant choke assembly. This choke assembly is for use in withstanding the abrasive action of sharp particles of silt and sand that are carried by hot fluids flowing under pressure from producing wells. This choke has a choke passage with an inlet end that has an angle of taper of less than 8°.

U.S. Pat. No. 4,644,974, issued on Feb. 24, 1987 to W. M. Zingg, describes a choke flow bean which is used to reduce pressure of fluids flowing through it. The choke flow bean has a well-rounded circular or elliptical throat which open slowly and directly into a divergent truncated exit cone having a divergent angle of from about 4° to about 8°. The length of the truncated exit cone can be up to about nine times the throat diameter. The outer surface of the choke flow bean is usually cylindrical in shape with external threads at the discharge end and a wrench fitting at the inlet end. The choke flow bean is embodied within the casing of a choke nipple.

U.S. Pat. No. 4,662,401, issued on May 7, 1987 to Zingg et al., teaches a high-pressure choke assembly in which pressurized fluid is “let-down” to atmospheric pressure as it passes through a choke assembly having a pair of pressure orifices which are in-line and directly opposite which are designed to leverage jet streams of generally equal force to a common in-line focal point. The choke assembly is a fixed-rate system where the volume throughput is regulated primarily by the pressure of the fluid.

U.S. Pat. No. 4,926,898, issued on May 22, 1990 to T. J. Sampey, shows a safety choke valve in which an upper part of the valve body has a tapered wall cavity which receives a tapered lower part of the valve bonnet in sealed engagement. An internally threaded cap member secures the sealed position of the bonnet on the valve body. The partial disengagement of the threads causes breaking of the sealed engagement and escape of pressure between the valve body and the bonnet.

U.S. Pat. No. 6,105,614, issued on Aug. 22, 2002 to Bohaychuk et al., provides a choke valve for throttling fluid flow. This choke valve has a cage with an external sleeve. The large ports of the cage are aligned with the axis of the inlet bore. A deflection bar is positioned at the top end of the main bore opposite the inlet bore. The flow patterns within the choke are consequentially altered with a significant reduction of localized erosional wear areas.

U.S. Pat. No. 6,214,092, issued on Apr. 10, 2001 to Odom et al., provides a fracturing material separator which allows for the venting of gases that percolate from the liquid constituent. A back pressure valve is disposed in communication therewith some as to maintain a positive pressure in the valve.

U.S. Pat. No. 6,446,664, issued on Sep. 10, 2002 the M. E. Parsons, describes a throttling choke valve having a wear sleeve lining the interior surface of the cylindrical passage downstream of the valve sealing mechanism. The wear sleeve has a removable retainer ring that fits between the wear sleeve and the fluid outlet. The retainer ring has a distal end that opens into a pipeline. At the distal end of the retainer ring, the thickness of the wall of the retainer is decreased such that the interior surface is curved outward toward the interior surface of the pipeline.

U.S. Pat. No. 6,695,010, issued on Feb. 24, 2004 to Robison et al., shows a segmented ceramic choke. This ceramic choke includes multiple segments of ceramic material that are fitted in side-by-side relationship.

U.S. Pat. No. 8,171,958, issued on May 8, 2012 to J. D. Morreale, provides an adjustable valve that includes a plug body having at least one flow path defined therein and a choke cage positioned proximate the plug body. The choke cage includes a plurality of openings that permit a flow of a fluid therethrough. The choke cage is adapted to be used to regulate the flow of fluid through the flow path in the plug body.

It is an object of the present invention to provide a fluid pressure release system that allows fluid pressures to be released in a safe and convenient manner.

It is another object of the present invention provide a fluid pressure release system that avoids erosion of the pressure-releasing components.

It is another object of the present invention provide a fluid pressure release system that employs a choke valve in which the choke bean can be replaceable.

It is still another object of the present invention provide a fluid pressure release system that avoids the need to throttle a valve during the release of pressures.

It is still a further object of the present invention to provide a fluid pressure release system which is easy to install, easy to use and relatively inexpensive.

These and other objects and advantages of the present invention will become apparent from a reading of the attached specification and appended claims.

### BRIEF SUMMARY OF THE INVENTION

The present invention is a fluid pressure release system for use in high pressure relief systems. The fluid pressure release system comprises a manifold having an interior passageway, a plug valve connected to the manifold in which the plug valve has an interior in communication with the interior passageway of the manifold, and a choke valve connected or interconnected to the plug valve. The plug valve is movable between a first position suitable for allowing a fluid to pass therethrough and a second position blocking fluid from passing therethrough. The choke valve includes a choke carrier having a first end and a second end. The first end is connected or interconnected to an end of the plug valve opposite the manifold. The choke carrier also has an internal bore. A choke bean is affixed within the internal bore of the choke carrier. The choke bean has a longitudinal bore extending therethrough. The longitudinal bore of the choke bean has an end adjacent to the second end of the choke carrier that is suitable for allowing the discharge of pressurized fluid therefrom.

In the fluid pressure release system of the present invention, a pipe is interposed between the plug valve and the choke valve. The pipe is longitudinally aligned with the plug valve and the choke valve. The first end of the choke carrier is affixed to an end of the pipe opposite the plug valve. A conduit is affixed to the second end of the choke carrier. The conduit has an interior passageway suitable for allowing the discharge of pressurized fluid to pass therethrough and outwardly to atmosphere.

The choke carrier has an internal shoulder formed in a location between the first and second ends thereof. The choke bean has an external shoulder bearing against this internal shoulder. The choke carrier also has an internally threaded area formed adjacent to the second end thereof. The choke bean has an externally threaded section formed adjacent to the end of the choke bean. The externally threaded section of the choke bean is threadedly engaged with the internally threaded area of the choke carrier. The longitudinal bore of the choke bean is axially centered within the choke bean. In the preferred embodiment the present invention, the choke bean is formed of a ceramic material.

The choke carrier also has an annular flange formed at the first end thereof. This annular flange extends outwardly of the first end of the choke carrier. A split sleeve is positioned against this annular flange of the choke carrier. The split sleeve has a shoulder extending outwardly therefrom. The coupler is rotatably positioned over the split sleeve. The coupler has an inner edge bearing against the shoulder of the split sleeve. The coupler is engaged with the first pipe. A retainer ring extends around the split sleeve. The retainer ring bears against the surface of the coupler. The coupler can have a wing extending radially outwardly therefrom. The choke carrier has an external thread at the second end thereof. An annular notch is formed inwardly of the second end. A lip seal is received in the annular notch of the choke carrier. One end of the choke bean has a wider diameter than the opposite end of the choke bean.

The present invention is also a choke valve for use in releasing pressure from a conduit of a stimulation and flow back operation. The choke valve includes a choke carrier having a first end and a second end and an internal bore. A choke bean is affixed within the internal bore of the choke carrier. The choke bean has a longitudinal bore extending therethrough. The longitudinal bore is suitable for allowing fluid pressures from the conduit of the fracturing operation to escape therefrom.

The choke carrier has an internal shoulder formed in a location between the first and second ends thereof. The choke bean has an external shoulder bearing against this internal shoulder.

The choke carrier also as an internally threaded area formed adjacent to the second end thereof. The choke bean has an externally threaded section formed adjacent to the end of the choke bean. The externally threaded section of the choke bean is threadedly engaged with the internally threaded area of the choke carrier. The longitudinal bore of the choke bean is axially centered within the choke bean.

The choke carrier has an annular flange formed at the first end thereof. This annular flange extends outwardly of the first end. A split sleeve is positioned against the annular flange of the choke carrier. The split sleeve has a shoulder extending outwardly therefrom. A coupler is rotatably positioned over the split sleeve. The coupler has an inner edge bearing against the shoulder of the split sleeve. The coupler is engaged with the first pipe. A retainer ring extends around the split sleeve. The retainer ring bears against a surface of the coupler. The coupler can have a wing extending radially outwardly therefrom. The choke carrier also has an external thread at the second end thereof. An annular notch is formed therein inwardly of the second end. A lip seal is received within the annular notch of the choke carrier.

This foregoing Section is intended describe, with particularity, the preferred embodiment of of the present invention. It is understood that modifications to this preferred embodiment can be made within the scope of the present claims without departing from the true spirit of the invention. As such, this Section should not be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a plan view showing the pressure release system in accordance with the preferred embodiment of the present invention.

FIG. 2 is a cross-sectional view of the body of the choke valve as used in the pressure release system of the present invention.

FIG. 3 is a side elevational view in partial cross section showing the use of the coupler as attached to an end of the choke valve of the present invention.

FIG. 4 is a side elevational view in partial cross section showing an alternative embodiment of the choke valve apparatus of the present invention.

### DETAILED DESCRIPTION OF THE INVENTION

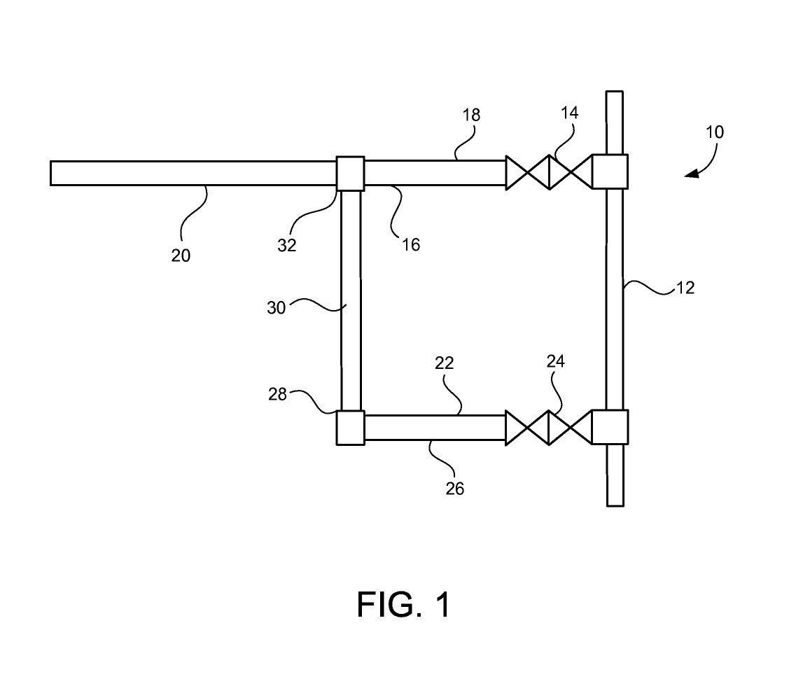

Referring to FIG. 1, there is shown the fluid pressure release system 10 in accordance with teachings of the present invention. The fluid pressure release system 10 includes a manifold 12, a plug valve 14 and a choke valve 16. The manifold 12 will have an interior passageway suitable for allowing high-pressure fluids to reside therein or pass therethrough. The plug valve 14 is connected to the manifold 12. The plug valve 14 will have an interior which is in communication with the interior passageway of the manifold. The plug valve, in the nature of conventional plug valves, is movable between a first position allowing the fluid from the interior of the manifold 12 to pass through the plug valve 14 and a second position that blocks fluid from passing through the plug valve 14. As such, the plug valve 14 acts as an on/off valve for the release of pressure. The plug valve 14 is not intended, in any way, as a “throttling” valve. Since the plug valve 14 is only designed for open/close operations, it can be built with enough structural integrity to withstand the erosive action by the high-pressure fluid and associated particles that would pass therethrough.

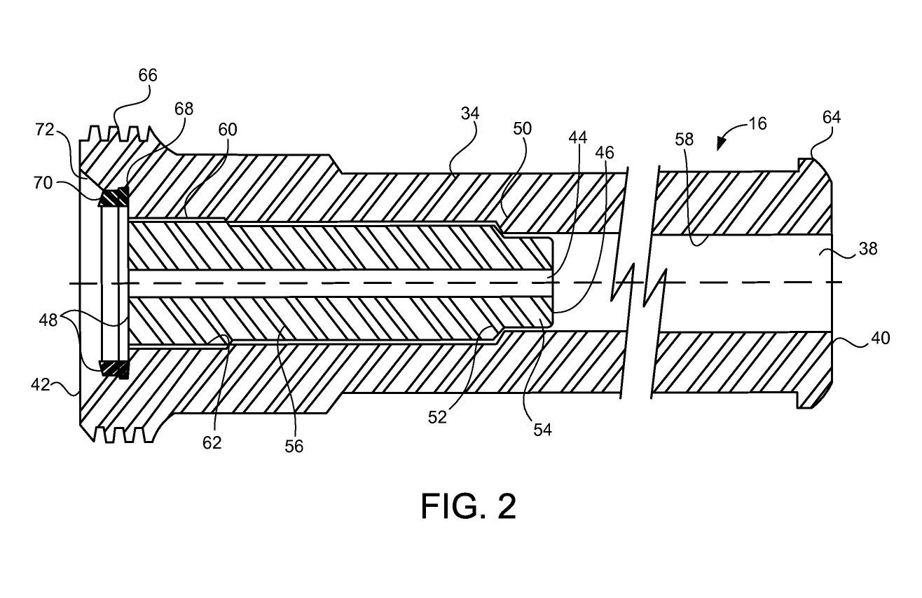

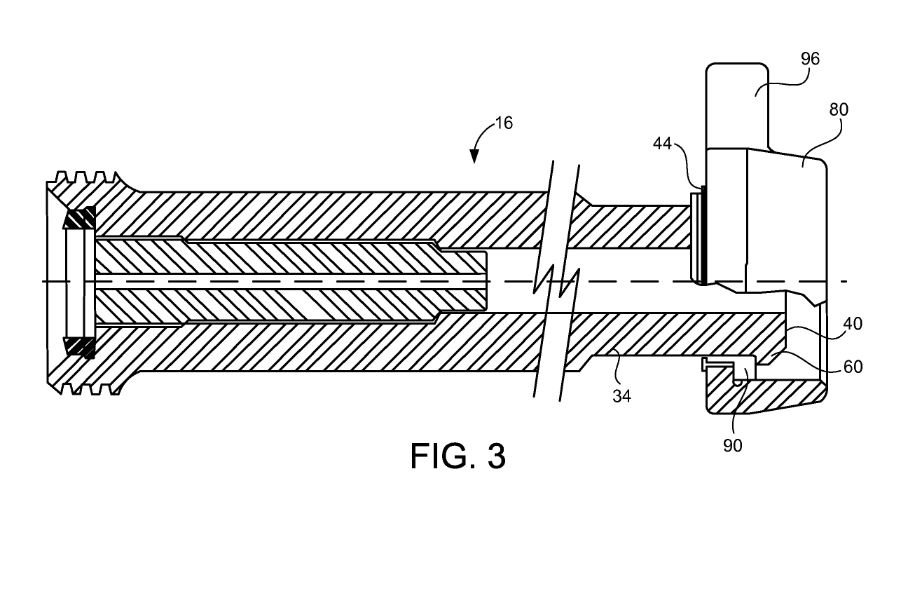

A pipe 18 is connected to an end of the plug valve 14 opposite the manifold 12. Pipe 18 is longitudinally aligned with the plug valve 14 and is illustrated as extending transverse to the longitudinal axis of the manifold 12. The choke valve 16 is affixed to an end of the pipe 18 opposite the plug valve 14. The choke valve 16 will have a configuration similar to that illustrated in FIGS. 2 and 3 herein. A conduit 20 is connected to the end of the choke valve 16 opposite the pipe 18. The conduit 20 is suitable for allowing the high-pressure fluids that pass through the plug valve 14 and through the interior of the choke valve 16 to pass outwardly to atmosphere.

Another piping system 22 is illustrated as part of the pressure release process. The alternative piping system 22 includes a control valve 24 that will communicate with the manifold 12. A first line 26 is connected to an end of the control valve 24 opposite the manifold 12. A junction 28 joins the opposite end of the line 26 to another line 30. The line 30 can also be connected by a junction 32 to the outlet of the choke valve 16 and/or to the conduit 20. This alternative piping 22 is simply a back-up system. If there is any failure of the plug valve 14 and/or the choke valve 16, the alternative piping 22 provides a back-up system whereby pressures can be released. In this system, the control valve 24 can be in the nature of a throttling valve that would only be opened under those circumstances where emergency procedures would be required and the primary system has failed.

FIG. 2 is a cross-sectional view of the choke valve 16 as used in the system 10 of the present invention. The choke valve 16 includes a choke carrier 34 and a choke bean 36. The choke carrier 34 has an internal bore 38 extending therethrough. The internal bore 38 extends from a first end 40 of the choke carrier 34 and opens to a second end 42 of the choke carrier 34. The choke bean 36 is affixed within the internal bore 38 of the choke carrier 34. The choke bean 36 has a longitudinal bore 44 that extends from a first end 46 to an opposite end 48 of the choke bean 36. The longitudinal bore 44 is entirely straight and is centrally positioned within the choke bean 36. Longitudinal bore 44 has an inner diameter that is suitable for allowing the discharge of pressurized fluid therethrough.

The choke carrier 34 has an internal shoulder 50 formed in a location between the first end 40 and the second end 42 thereof. It can be seen that the choke bean 36 has an external shoulder 52 that will bear against the internal shoulder 50 of the choke carrier 34. This relationship between the internal shoulder 50 and the external shoulder 52 assures that the choke bean 36 is securely planted within the internal bore 38 of the choke carrier 34. Additionally, this shoulder-to-shoulder configuration resists any potential movement of the choke bean in a direction toward the first end 40 of the choke carrier 34. The external shoulder 52 of the choke bean 36 defines a small diameter section 54 of the choke bean 36 and a wide diameter section 56 of the choke bean 36. This small diameter section 54 of the choke bean 36 will minimize the surface area at the end 46 of the choke bean 36. As such, the turbulence caused by the inrush of high-pressure fluid is minimized. This small diameter section 54 will, in effect, “funnel” the high-pressure fluid toward the longitudinal bore 44. Additionally, the small diameter section 54 is firmly mounted in surface-to-surface contact against the internal wall 58 of the internal bore 38 of the choke carrier 34. As a result, this will be resistive of the high-pressure fluid flowing around the exterior of the small diameter section 54 and into the spaces between the choke bean 36 and the inner wall 58 of the choke carrier 34. Additionally, and furthermore, the relationship between the external shoulder 52 of the choke bean 36 and the internal shoulder 50 of the choke carrier 34 will serve as a seal so as to further prevent the high-pressure fluid from entering the space between the outer surface of the large diameter section 56 of the choke bean 36 and the inner wall 58 of the internal bore 38. This relationship greatly and surprisingly enhances the fluid dynamics associated with the passage of the high-pressure fluid through the choke valve 16.

The choke carrier 34 includes an internally threaded area 60 located adjacent to the second end 42 thereof. Similarly, the choke bean 36 includes an externally threaded section 62 adjacent to the end 48 thereof. The externally threaded section 62 of the choke bean 36 is threadedly received by the internally threaded area 60 of the choke carrier 34. This threaded connection strongly retains the choke bean 36 within the internal bore 38. As such, this strong threaded connection prevents any potential dislodgment of the choke bean as a result of encountering the high-pressure fluid. The engagement between the external thread 36 of the choke bean 36 and the internal thread 60 of the choke carrier 34 further acts to seal these internal surfaces together so as to prevent the passage of the high-pressure fluid on the outside of the choke bean 36. This enhances the ability of the high-pressure fluid to be delivered through the longitudinal bore 44 of the choke bean 36.

The longitudinal bore 44 is axially centered within the choke bean 36. As such, the longitudinal bore 44 is located in that precise position where the flow of high-pressure fluids will be directed. Additionally, so as to prevent erosion, the choke bean 36 can be formed of materials that can strongly withstand any potential erosion and damage caused by contact with high-pressure fluids and the abrasive particles associated therewith. As such, the tungsten carbide choke bean 36 will resist any potential damage and have an extremely long life. If any damage should occur, then it would be a relatively simple procedure to unscrew the choke bean 36 from the internal thread 60 of the choke carrier 34 and to replace the choke bean 36 with another choke bean. During this time, the choke carrier 34 can remain in place and connected or interconnected to the plug valve 14.

The choke carrier 34 has an annular flange 64 formed at the first end 40. The annular flange 64 extends outwardly of the outer diameter of the choke carrier 34. An external thread 66 is formed at the end 42 of the choke carrier 34. The external thread 66 can be in the nature of an acme thread. This thread 66 can be strongly connected to the internal threads formed on the conduit 20. An annular notch 68 is formed inwardly of the second end 42 of the choke carrier 34. A lip seal 70 is positioned within this annular notch 68. A tapered opening 72 extends from the end 42 and tapers inwardly so as to reduce in diameter toward the lip seal 70. As such, the connecting end of the conduit 20 can be securely affixed against seal 72 so as to establish a sealing relationship therewith. Additionally, the strong engagement of the conduit 20 against the lip seal 70 will compress the lip seal 78 so as to create a very strong fluid-tight seal within the notch 68. Once again, this seal further prevents against any release of the fluid pressure from around the exterior of the choke bean 36.

FIG. 3 particularly shows the use of a coupler 80 as affixed over the first end 40 of the choke carrier 34. In FIG. 3, the annular flange 64 is particularly illustrated. A split sleeve 90 is positioned against this annular flange 64. The split sleeve 90 has a shoulder extending outwardly therefrom. The wing union 88 is rotatably positioned over the split sleeve 90. The wing union 88 has an inner edge 92 that bears against the shoulder of the split sleeve 90. This wing union 88 can be suitably engaged with the pipe 18 in a secure manner. A retainer ring 94 extends around the split sleeve 90. The retainer ring 94 bears against a surface of the wing union 88. As such, the wing union 88 is retained in position in a generally fluid-tight manner over the exterior of the choke carrier 34.

A wing 96 extends radially outwardly of the wing union 88. Wing 96 facilitates the ability to rotate the coupler for the quick and easy removal of the wing union 88. As such, rotational forces can be applied to the wing 96 to facilitate the release of the wing union 88 from the attached pipe. The choke valve 16 of the present invention can be easily connected to or disconnected from the plug valve, or the pipe extending therefrom. This facilitates quick and easy repair or replacement of the choke valve 16.

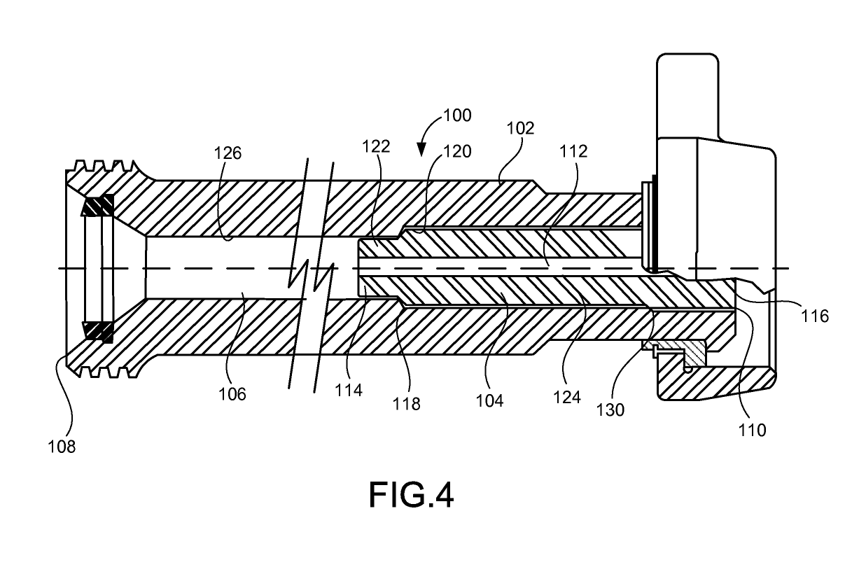

FIG. 4 shows an alternative embodiment of the choke valve assembly 100 in which the choke valve assembly 100 is configured for an opposite flow of fluid. In FIG. 4, the flow of fluid can actually be in either direction. In particular, in FIG. 4, the choke valve assembly 100 includes a choke carrier 102 and a choke bean 104. The choke carrier 102 has an internal bore 106 extending therethrough. The internal bore 106 extends from a first end 108 of the choke carrier 102 and opens at an opposite end 110. The choke bean 104 is affixed within the internal bore 106 of the choke carrier 102. The choke bean 104 has a longitudinal bore 112 that extends from a first end 114 to a second end 116 of the choke bean 104. The longitudinal bore 112 is entirely straight and is centrally positioned within the choke bean 104. Longitudinal bore 112 has an inner diameter that is suitable for allowing for the discharge of pressurized fluid therethrough.

The choke carrier 102 has an internal shoulder 118 formed in a location between the first end 108 in the second end 110 thereof. It can be seen that the choke bean 104 has an external shoulder 120 that bears against the internal shoulder 118 of the choke carrier 102. This relationship between the internal shoulder 118 and the external shoulder 120 assures that the choke bean 104 is securely planted within the internal bore 106 of the choke carrier 102. Additionally, this shoulder-to-shoulder configuration resists any potential movement of the choke bean in a direction toward the first end 108 of the choke carrier 102. The external shoulder 120 of the choke bean 104 defines a small diameter section 122 of the choke bean 104 and a wide diameter section 124 of the choke bean 104. The small diameter section 122 of the choke beam 104 will minimize the surface area at the end 114 of the choke bean 124. As such, the turbulence caused by the inrush of high-pressure fluid through the internal bore 106 from the first end 108 of the choke carrier 102 is minimized. This small diameter section 122 will, in effect, “funnel” the high-pressure fluid toward the longitudinal bore 112. Additionally, this small diameter section 122 is firmly mounted in surface-to-surface contact against the internal wall 126 of the internal bore 106 of the choke carrier 102. As a result, this will be resistive of the high-pressure fluid flowing around the exterior of the small diameter section 114 and into the spaces between the choke bean 104 and the inner wall 126 of the choke carrier 102. Additionally, and furthermore, the relationship between the external shoulder 120 of the choke bean 104 and the internal shoulder 118 of the choke carrier 102 will serve as a seal so as to further prevent the high-pressure fluid from entering the space between the outer surface of the large diameter section 124 of the choke bean 104 and the inner wall 126 of the internal bore 106. This relationship greatly and surprisingly enhances the fluid dynamics associated with the passage of the high-pressure fluid through the choke valve assembly 100.

The choke carrier 102 includes an internally threaded area 130 adjacent to the second end 110 thereof. Similarly, the choke bean 104 includes an externally threaded section that is threadedly received by the internally threaded area 130 of the choke carrier 102. This threaded connection strongly retains the choke bean 104 within the internal bore 106. As a result, this strong threaded connection prevents any potential dislodgment of the choke bean 104 as a result of encountering the high-pressure fluid. The engagement between the external threat of the choke bean 104 and the internal thread 130 of the choke carrier 102 further acts to seal these internal surfaces together so as to prevent the passage of the high-pressure fluid on the outside of the choke bean 104. This enhances the ability of the high-pressure fluid to be delivered through the longitudinal bore 106. This enhances the ability of the high-pressure fluid to be delivered to the longitudinal bore 112 of the choke bean 104.

The longitudinal bore 112 is axially centered within the choke bean 104. As such, the longitudinal bore 112 is located in that precise location with the flow of high-pressure fluids will be directed. As stated hereinbefore, if any damage should occur, then it is a relatively simple procedure to unscrew the choke bean 104 from the internal thread 130 of the choke carrier 102 and to replace the choke bean 104 with another choke bean. During this time, the choke carrier 102 can remain in place and the connected or interconnected to the plug valve.

In normal operating conditions, it is known that the amount of pressure that will be accommodated by the piping of the stimulation system. As a result, easy calculations can be made as to the proper diameter of the longitudinal bore 44 of the choke bean 36. It is believed that the longitudinal bore 44 should have a diameter of up to one inch. The size of the bore can be enlarged so as to accommodate greater pressures or reduced to accommodate lesser pressures.

When it is desired to release pressure from the system, the plug valve is initially opened. As a result of this opening, the high-pressure fluid can flow in a controlled manner through the longitudinal bore 44 of the choke bean 36 within the choke carrier 34. As such, the release of pressure is achieved in a consistent and constant manner. The present invention avoids the need to throttle a valve so as to slowly release pressure and then greatly release pressure. The strong materials used for the choke bean 36 greatly resists wear. As such, the present invention avoids the need to constantly replace damaged or eroded throttle valves. The choke valve 16 of the present invention would require no human intervention in order to achieve the pressure release. The only human intervention that is necessary is the opening and closing of the plug valve. The choke valve 16 serves to slowly bleed high-pressure fluids in a safe, convenient and efficient manner.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A fluid pressure release system for use in a stimulation operation, the fluid pressure release system comprising:
a piping system having an interior passageway;
a plug valve connected to said piping system, said plug valve having an interior in communication with said interior passageway of said manifold, said plug valve movable between a first position suitable for allowing a fluid to pass therethrough and a second position blocking fluid from passing therethrough; and
a choke valve connected or interconnected to said piping system, said choke valve comprising:
a choke carrier having a first end and a second end, said first end connected or interconnected to an end of said plug valve opposite said piping system, said choke carrier having an internal bore; and
a choke bean affixed within said internal bore of said choke carrier, said choke bean having a longitudinal bore extending therethrough, said longitudinal bore of said choke bean having an and adjacent said second end of said choke carrier that is suitable for discharge of pressurized fluid therefrom.

2. The fluid pressure release system of claim 1, further comprising:
a pipe interposed between said plug valve and said choke valve, said pipe being longitudinally aligned with said plug valve and said choke valve, said first end of said choke carrier affixed to an and of said pipe opposite said plug valve.

3. The fluid pressure release system of claim 1, further comprising:
a conduit affixed to said second end of said choke carrier, said conduit having an interior passageway suitable for allowing the discharged pressurized fluid to pass therethrough and to the atmosphere.

4. The fluid pressure release system of claim 1, said choke carrier having an internal shoulder formed in a location between said first and second ends thereof, said choke bean having an external shoulder bearing against said internal shoulder.

5. The fluid pressure release system of claim 1, said choke carrier having an internally threaded area formed adjacent said second end thereof, said choke bean having an externally threaded section formed adjacent said end of said choke bean, said externally threaded section of said choke bean threadedly engaged with said internally threaded area of said choke carrier.

6. The fluid pressure release system of claim 1, said longitudinal bore of said choke bean being axially centered within said choke carrier.

7. The fluid pressure release system of claim 2, the choke valve further comprising:
a split sleeve positioned against said annular flange of said choke carrier, said split sleeve having a shoulder extending outwardly therefrom; and
a wing union rotatably positioned over said split sleeve, said wing union having an inner edge bearing against said shoulder of said split sleeve, said wing union engaged with said first pipe.

8. The fluid pressure release system of claim 7, said choke valve further comprising:
a retainer ring extending around said split sleeve, said retainer ring bearing against a surface of said coupler, said wing union having a wing extending radially outwardly therefrom.

9. The fluid pressure release system of claim 1, said choke carrier being externally threaded at said second end thereof, said choke carrier having an annular notch formed therein inwardly of said second end, said choke valve further comprising:
a lip seal received in said annular notch of said choke carrier.

10. The fluid pressure release system of claim 1, said end of said choke bean having a wider diameter than an opposite end of said choke bean.

11. The fluid pressure release system of claim 1, said piping system being a manifold.

12. A choke valve for use in releasing pressures from a conduit of a stimulation operation, the choke valve comprising:
a choke carrier having a first end and a second end, said choke carrier having an internal bore; and
a choke bean affixed within said internal bore of said choke carrier, said choke bean having a longitudinal bore extending therethrough, said longitudinal bore of said choke bean having an end adjacent said second end of said choke carrier that is suitable for discharge of pressurized fluid therefrom.

13. The choke valve of claim 12, said choke carrier having an internal shoulder formed in a location between said first and second ends thereof, said choke bean having an external shoulder bearing against said internal shoulder.

14. The choke valve of claim 12, said choke carrier having an internally threaded area formed adjacent said second end, said choke bean having an externally threaded section formed adjacent said end of said choke bean, said externally threaded section of said choke bean threadedly engaged with said internally threaded area of said choke carrier.

15. The choke valve of claim 12, said longitudinal bore of said choke bean being axially centered within said choke bean.

16. The choke valve of claim 12, said choke carrier being formed of a steel material.

17. The choke valve of claim 12, the choke valve further comprising:
a split sleeve positioned against said annular flange of said choke carrier, said split sleeve having a shoulder extending outwardly therefrom; and
a wing union rotatably positioned over said split sleeve, said wing union having an inner edge bearing against said shoulder of said split sleeve.

18. The choke valve of claim 17, further comprising:
a retainer ring extending around said split sleeve, said retainer ring bearing against a surface of said wing union, said wing union having a wing extending radially outwardly therefrom.

19. The choke valve of claim 12, said choke carrier having an external thread at said second end thereof, said choke carrier having an annular notch formed therein inwardly of said second end, said choke valve further comprising:
a lip seal received in said annular notch of said choke carrier.

20. The choke valve of claim 17, said end of said choke bean having a wider diameter than an opposite end of said choke bean.
